(19) United States
(12) Patent Application Publication
(10) Pub. No.: US 2013/0173776 A1
(43) Pub. Date: Jul. 4, 2013

(54) Method and Apparatus for Wirelessly Managing a Classroom Environment

(71) Applicant: Marvell World Trade Ltd., St. Michael (BB)

(72) Inventors: Jack Kang, Sunnyvale, CA (US); Tonya McCrary Brilon, Mountain View, CA (US)

(73) Assignee: MARVELL WORLD TRADE LTD., St. Michael (BB)

(21) Appl. No.: 13/718,866

(22) Filed: Dec. 18, 2012

Related U.S. Application Data
(60) Provisional application No. 61/583,137, filed on Jan. 4, 2012.

(51) Int. Cl. H04L 12/24

(52) U.S. Cl. CPC H04L 12/24; H04L 63/02
USPC 709/223; 726/11

(57) ABSTRACT

This disclosure describes devices, methods, and techniques for managing a classroom environment. These devices, method, and/or techniques enable a classroom manager device to manage a wireless classroom environment.

### RELATED APPLICATION

This present disclosure claims priority to U.S. Provisional Patent Application Ser. No. 61/583,137, filed Jan. 4, 2012, the disclosure of which is incorporated herein by reference.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The importance of education to modern society cannot be overstated. However, access to tools that may be utilized to enhance education may vary greatly, such as due to budget and technological limitations that may be encountered in depressed and/or underserved areas. Additionally, conventional techniques that are utilized to implement technology, even when available, can interfere with a classroom experience and thus may hinder a student's education, such as due to distractions and so forth.

### SUMMARY

This summary is provided to introduce subject matter that is further described below in the Detailed Description and Drawings. Accordingly, this Summary should not be considered to describe essential features nor used to limit the scope of the claimed subject matter.

A classroom manager device is described that includes a housing. The classroom manager device includes a wireless router disposed within the housing and configured to instantiate a local wireless network and support communication with a wide area network. The classroom manager device further includes a server disposed within the housing and configured to receive the electrical power for operation, the server communicatively coupled to the wireless router to manage a wireless classroom environment involving a teacher device that is configured to manage operation of one or more student devices.

A method is described that is implemented by one or more computing devices of a service provider. The method includes receiving heuristic data collected by a plurality of classroom manger devices, each of the classroom manager devices configured to support a wireless classroom environment to manage dissemination of classroom content to a plurality of student devices and collect the heuristic data that describes interaction performed with the classroom content by respective said student devices. The method also includes exposing a result of an analysis of the received heuristic data, the analysis performed to determine how the interaction was performed with different portions of the classroom content by the respective student devices.

One or more computer-readable storage media are described that comprise instructions stored thereon that, responsive to execution on a computing device, causes the computing device to perform operations. The operations include obtaining data via a local wireless network from a classroom manager device, the classroom manager device having collected the data via the local wireless network from a plurality of student devices, the data describing consumption of classroom content by respective ones of the student devices. The operations also include displaying the obtained data in a user interface by the computing device, the user interface configured to control which portions of the classroom content are consumed by the respective ones of the student devices.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different instances in the description and the figures indicate similar or identical items.

FIG. 1 illustrates an operating environment in which a classroom manager device having wireless functionality may be implemented.

FIG. 2 is an illustration of an example implementation of a classroom manager device of FIG. 1

FIG. 3 depicts a system in an example implementation showing a wireless router and server of FIG. 1 in greater detail as well as classroom content that is configured to be managed by the classroom manager device.

FIG. 4 depicts a system in an example implementation in which heuristic data is collected and analyzed.

FIG. 5 depicts a system in an example implementation in which management of one or more student devices by a teacher device is shown.

FIG. 6 depicts a system in an example implementation in which communication between student devices by the classroom manager device is shown.

FIG. 7 is a flow diagram depicting an example method of analysis of heuristic data.

FIG. 8 illustrates a System-on-Chip that is capable of implementing portions of a device of FIGS. 1-6.

### DETAILED DESCRIPTION

### Overview

Devices, systems, and techniques are described that are usable to manage a classroom environment. A classroom manager device, for example, may be configured to include a wireless router and a server. This device may assume a variety of configurations, such as a mobile configuration in which that device is designed for ease of transport between classrooms. For example, the classroom manager device may include a housing and an electrical plug that is configured to be received in an electrical socket. Further, the housing may be sized such that when the electrical plug is received in an electrical socket in a vertical orientation, the housing may be secured by and thus “hang” from the socket. In this way, the classroom manager device may be easily installed in a classroom to manage a wireless classroom environment. Other implementations are also contemplated, such as battery powered implementations.

Additionally, the classroom manager device may be configured to manage the wireless classroom environment in a variety of ways. For example, the wireless classroom environment may be managed such that control of student devices is given to a teacher device. The teacher device, for instance, may be configured such that the teacher device may monitor which portions of classroom content are output by respective student device, may control those portions, evaluate interaction with these portions, and so on.

In another example, analytics may be supported through use of the classroom manager device. Heuristic data may be collected from student devices that describe interaction with the classroom content, such as amount of time spent with particular portions, changes made to answers, correspondence between amount of time spent and correct/incorrect answers, and so on. These analytics may then be employed to support a variety of functionality, such as to improve particular sections, to get feedback to “know what works,” and so on.

In a further example, the classroom manager device may be utilized to manage interaction permitted by the student devices. This may include acting as a firewall to permit access to a wide area network, such as the internet. This may also include management of interaction of the student devices with each other. A variety of other examples are also contemplated, such as to manage dissemination and collection of assignments, attendance, and so forth, further discussion of which may be found in relation to the following sections.

In the discussion that follows, an operating environment having an example device is first described, though this example system is not intended to limit the techniques or claims herein. Methods are then described, which may be employed in the system as well as by other systems. In the discussion below, reference will be made to the environment by way of example only and, therefore, implementations described below are not limited to the described environment.

Operating Environment

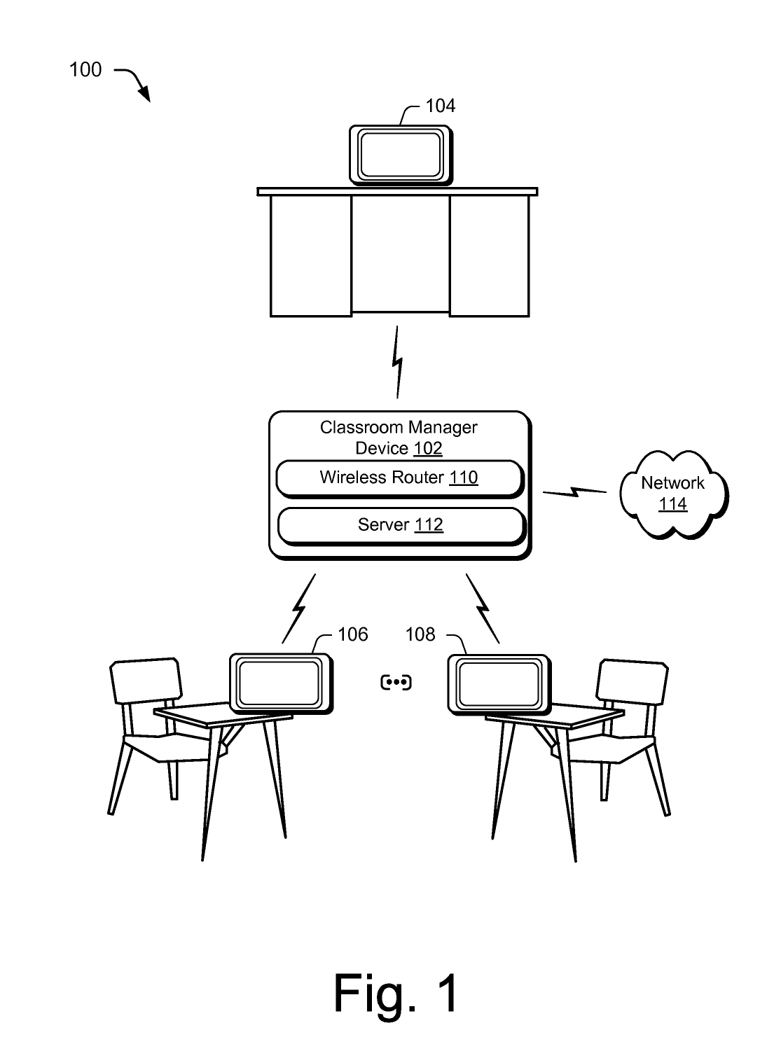

FIG. 1 illustrates an operating environment 100 having a classroom manager device 102 that is configured to implement a wireless classroom environment. The wireless classroom environment, for instance, may include a teacher device 104 and a plurality of student devices 106, 108. The devices 102, 104, 106, 108 may be configured in a variety of ways.

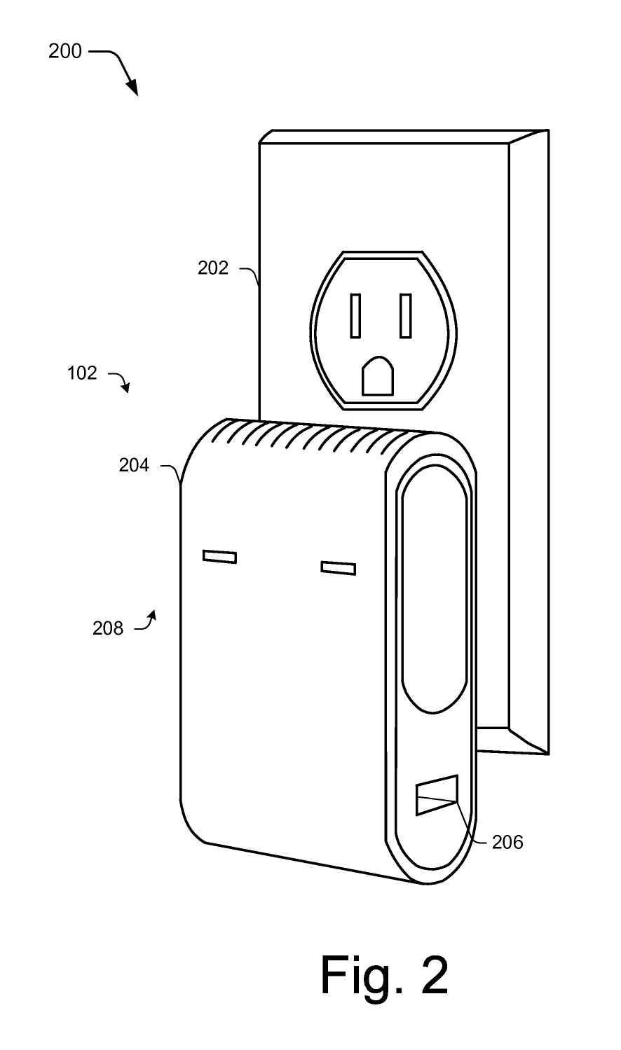

For example, the classroom manager device 102 may be configured as a mobile device, e.g., a mobile phone, tablet computer, portable game device, dedicated mobile device, and so on. In this way, the classroom manager device 102 may support ease of transport between classroom, an example of which is shown in FIG. 2 A variety of other examples are also contemplated, such as a television, wearable device, projector and so on.

Likewise, the teacher device 104 and student devices 106, 108 may also be configured in a variety of ways. These devices 104, 106, 108 may also be configured in a mobile configuration, such as a tablet as illustrated, mobile phone (e.g., a smart phone), portable game device, and so on. Other examples are also contemplated, such as a desktop personal computer, laptop computer, and so forth. Further, different amounts of functionality may be supported in the different configurations. For instance, the teacher device 104 and/or the student devices 106, 108 may range from full-resource devices with substantial memory and processor resources (e.g., personal computers, game consoles) to low-resource devices with limited memory and/or processing resources (e.g., thin tablet devices). In such a low resource device implementation, the classroom manager device 102 may be configured to stream content as further described below. The devices may also include software stored thereon that causes hardware of the device to perform one or more operations.

The classroom manager device 102 is illustrated as including a wireless router 110 and a server 112, which may be implemented as one or more modules disposed within a housing of the classroom manager device 102.

The wireless router 110 is representative of functionality to provide a local wireless network. The local wireless network may be configured in a variety of ways, such as in accordance with one or more IEEE standards, Bluetooth, and so on. The wireless router 110 may also be configured to support access to a wide area network, which is represented by network 114 in the illustration.

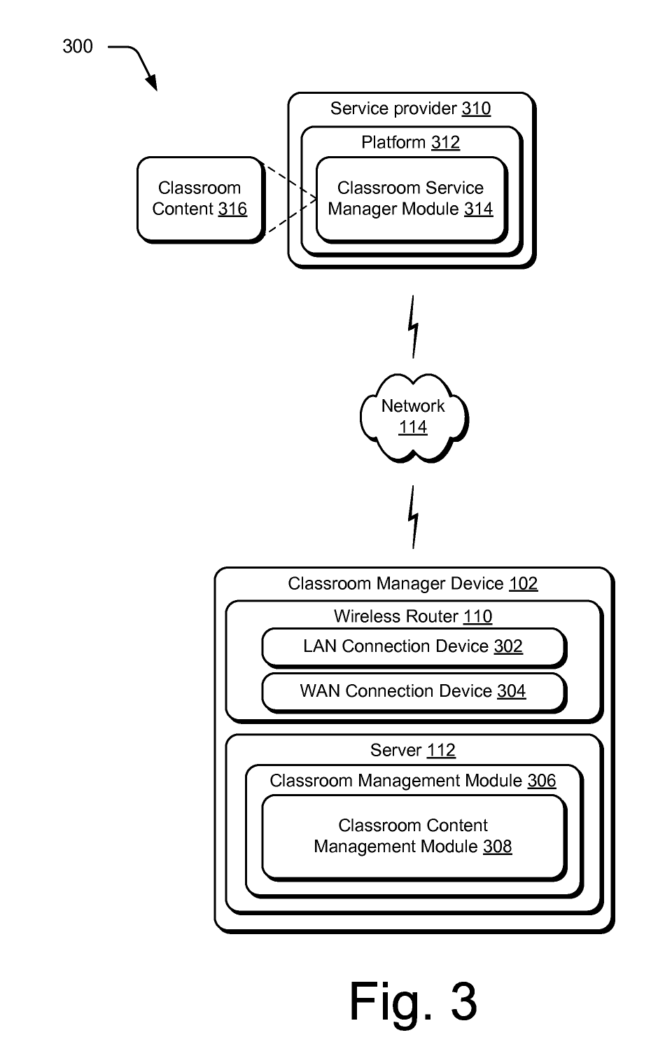

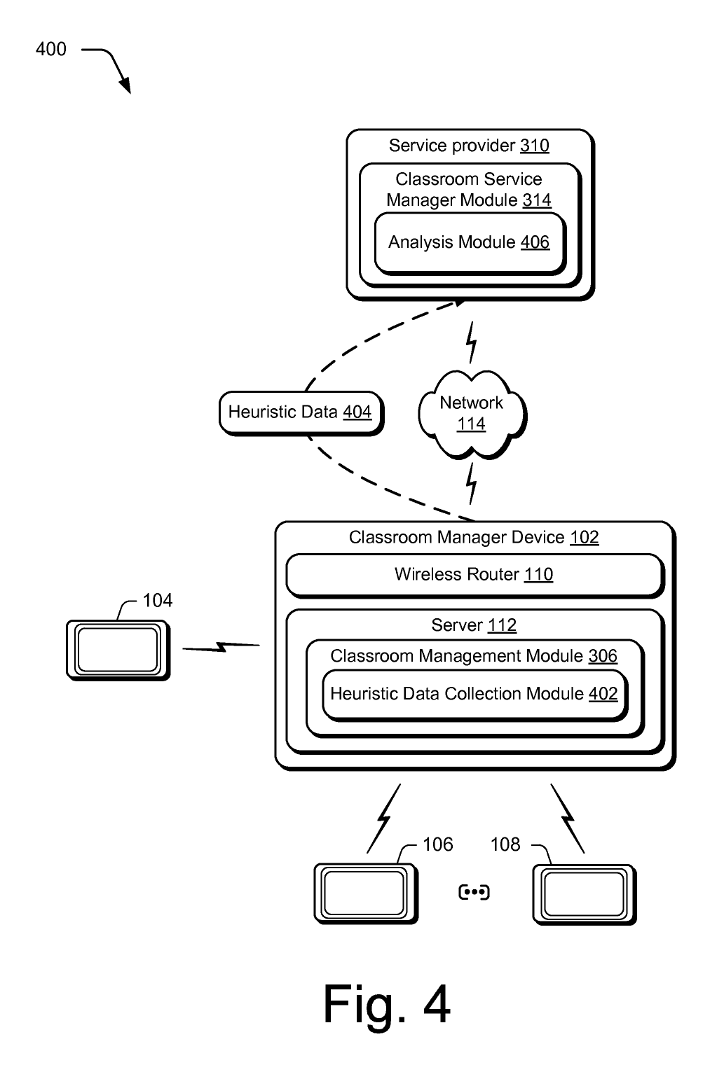

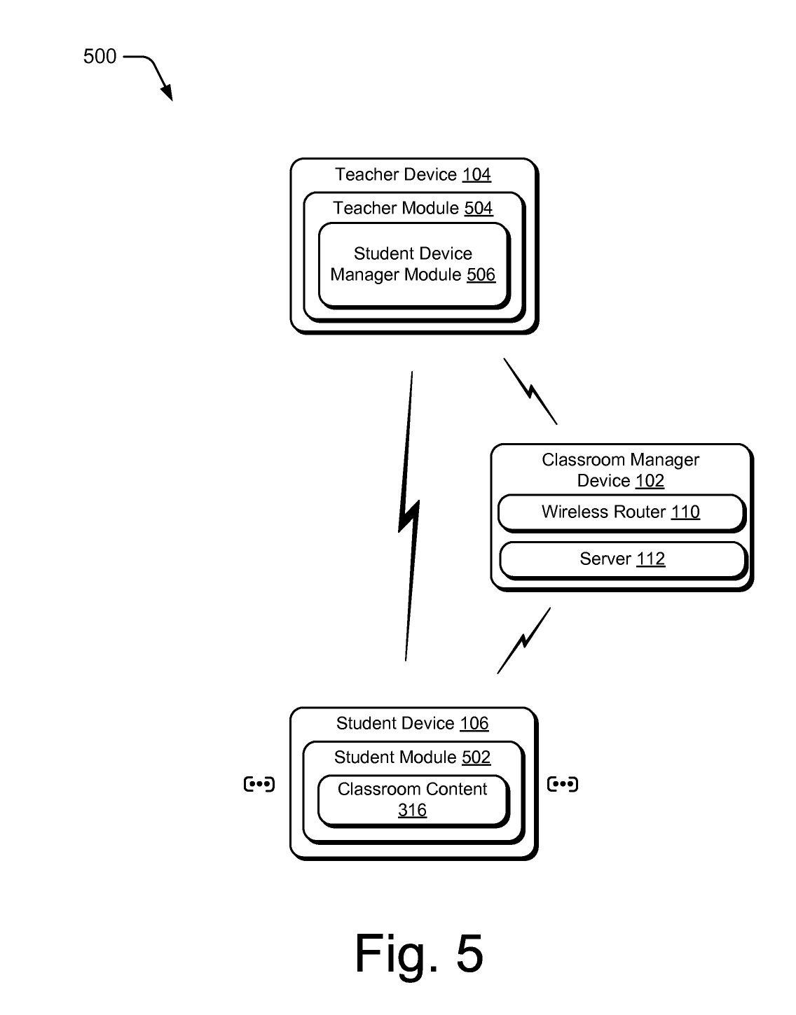

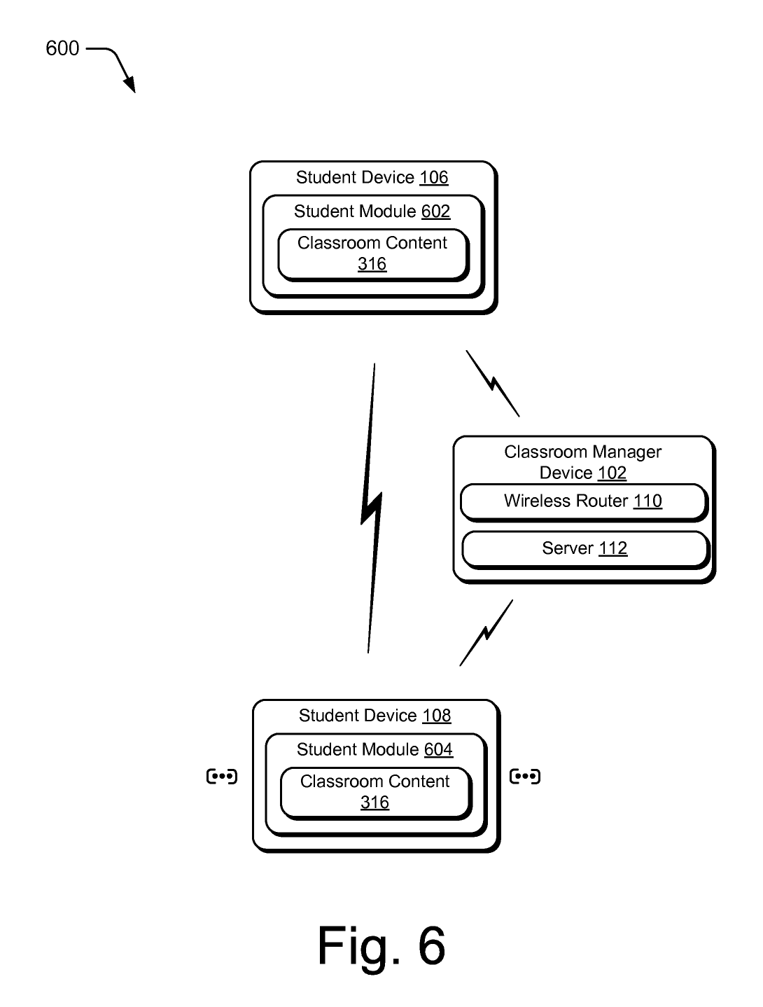

The server 112 is representative of functionality of the classroom manager device 102 to manage a wireless classroom environment using the wireless router 110. This management may be performed in a variety of ways. For example, this management may include obtaining and disseminating classroom content as further described in relation to FIG. 3. Management supported by the classroom manager device 102 may also include support of analytics, such as to process heuristic data that describes student interaction with the classroom content as further described in relation to FIG. 4. Management supported by the classroom manager device 102 may also include support of techniques such that a teacher device may control interaction of the student devise with classroom content, assignments, attendance, and so on as further described in relation to FIG. 5. Management supported by the classroom manager device 102 may also include management of student devices with each other as further described in relation to FIG. 6.

FIG. 2 is an illustration of an example implementation 200 of the classroom manager device 102 of FIG. 1. In this example, the classroom manager device 102 is illustrated as being secured to an electrical socket of an electrical outlet 202. The classroom manager device 102, for instance, may include an electrical plug, e.g., two prong, three prong, or in compliance with a variety of other configurations, that is fixed to the housing, is rotatable in relation to the housing, and so forth. The electrical plug is configured to be inserted into the electrical socket. The classroom manager device 102 may further include a housing that is configured such that when received within the electrical socket in a vertical orientation, the housing 204 is supported to hang from the electrical socket of the electrical outlet 202 as illustrated. In this way, the classroom manager device 102 may support ease of transport between classrooms in a mobile configuration.

The classroom manager device 102 may also be configured to support a variety of other functionality. The classroom manager device 102, for instance, is illustrated as including a bus connector 206, such as a USB or other connector. The bus connector 206, for instance, may be utilized to connect peripherals to the classroom manager device 102 and thus may serve as a peripheral connector. Additionally, the bus connector 206 may be utilized to access external memory that includes classroom content. The bus connector 206 may also be utilized to support external access to functionality of the classroom manager device 102, such as to obtain completed assignments, download attendance information, perform software updates, and so on. Although not shown, the housing 204 may also include a physical network connection (e.g., on a plug side of the housing 204) to support a physical and communicative coupling to a wide area network.

The classroom manager device 102 may also be configured to include indicator lights 208 to indicate an operational status of the classroom manager device 102. The indicator lights 208, for instance, may indicate an operational status of a local wireless network, availability of a wide area network, whether a wireless classroom environment is enabled, and so on. A variety of other functionality may also be incorporated by the classroom manager device 102.

FIG. 3 depicts a system 300 in an example implementation showing the wireless router and server 112 of FIG. 1 in greater detail as well as classroom content that is configured to be managed by the classroom manager device 102. In this example, the wireless router 110 is illustrated as including a LAN connection device 302 and a WAN connection device 304. The LAN connection device 302 is representative of functionality to implement a local wireless area network, such as in compliance with one or more IEEE standards, Bluetooth, or other wireless network configurations. The WAN connection device 304 is representative of functionality to connect to a WAN, such as the internet. The WAN connection device 304 may connect in a variety of ways, such as through a physical and communicative coupling, a wireless communicative coupling, e.g., cellular such as LTE, 4G, 3G, and so forth.

The server 112 is illustrated as including a classroom management module 306. The classroom management module 306 is representative of functionality to manage a wireless classroom environment, such as an environment that includes the teacher device 104 and student devices 106, 108. An example of this functionality is illustrated as a classroom content management module 308. The classroom content management module 308 is representative of functionality to manage dissemination of classroom content through the wireless classroom.

The classroom content management module 308, for instance, may communicate with a service provider 310 via a network that is configured to implement one or more services, e.g., through use of one or more servers of a server farm. Accordingly, the service provider 310 in this instance implements a platform 312 to support such services, an example of which is illustrated as a classroom service manager module 314. The classroom service manager module 314 may also be configured to support a variety of services, such as to offer classroom content 316 via the network 114.

Thus, the classroom content management module 308 may communicate with the service provider 310 via the network 114 to obtain classroom content 316. This may involve a variety of different revenue techniques, such as a subscription service, pay per use, and so forth. Further, the classroom content manager module 314 may employ a variety of techniques to make the content available, including use of encryption, streaming, and so forth. Further, the service provider 310 may be leveraged to support a variety of other functionality, such as analytics, an example of which is described as follows and shown in a corresponding figure.

FIG. 4 depicts a system 400 in an example implementation in which heuristic data is collected and analyzed. In this example, the classroom management module 306 is illustrated as including a heuristic data collection module 402. This module is representative of functionality to collect heuristic data 404 from student devices 106, 108 and even from a teacher device 104.

The heuristic data 404 collected from the student devices 106, 108 may describe a variety of different interactions of students with the devices. The heuristic data 404, for instance, may describe interaction with the classroom content, such as reading material, diagrams, images, multimedia content, and so on. Further, this heuristic data 404 may describe interaction with particular portions of the classroom content and even changes made as part of that interaction. The heuristic data 404, for instance, may describe an amount of time that particular portions were output, interactions with the particular portions, answers input by a student and even changes made to answers by the student when interacting with the device, and so on.

Heuristic data 404 may even be collected from the teacher device 104. In this instance, the heuristic data 404 may describe navigation through the classroom content performed during a teaching session, an amount of time particular portions of the classroom content were output, and so on.

Regardless of where originated, the heuristic data 404 may then be analyzed, such as to determine effectiveness of the classroom content. An analysis module 406, for instance, may be employed by the service provider 301 to analyze the heuristic data 404. This may include determination of how interaction with the classroom content was performed to study the content. This analysis may also take into account answers received from students in relation to this classroom content.

A correlation may then be performed as part of this analysis between the answers, amount of time spent at particular portions, an amount of time spent discussing the particular portions, and so on. A result of the analysis may then be exposed (e.g., via a user interface, output as part of a written document, and so on) such that a user may readily identify portions of the classroom content, lecture performed using the classroom content, as well as questions asked in relation to the classroom content that could use improvement, portions that are functioning as intended, and so on. In this way, the analytics may be used to provide a real world analysis of the effectiveness of the classroom content, students that interact with the content, and even teachers that teach the content. A variety of other examples are also contemplated.

The classroom manager device 102, for instance, may employ the classroom management module 306 to track attendance of students based on a detected presence of student devices 106, 108 in the local wireless network. This attendance may even be “checked” such that a determination is made as to whether the student is actually present through interaction with the student device 106, 108, use of a unique identifier to login, and so forth.

The classroom management module 306 may also be employed to manage dissemination and collection of classroom content that includes assignments. For example, an assignment and supporting materials may be locally stored on the student devices 106, 108. At a later point in time, answers provided to questions in the assignments may then be collected by the server 112. This information may then be communicated via the network 114 for processing by the service provider 310 (e.g., automatically and/or cached and forwarded in response to an available WAN connection), forwarded to a teacher device 104, and so forth. In another example, classroom statistics and heuristics may be calculated (e.g., student test results, attendance, and so on) and communicated to a service without interference and/or manipulation by a teacher. Thus, in this case a teacher is prevented from manipulating, skewing, and even knowing test results of students Further discussion of teacher/student interaction that may be supported by the wireless classroom environment may be found in relation to the following description and corresponding figure.

FIG. 5 depicts a system 500 in an example implementation in which management of one or more student devices 106 by a teacher device 104. The student device 106 is illustrated as including a student module 502 that is representative of functionality of the device to interact with classroom content 316. This may include output of classroom content (e.g., from local storage, streamed from a classroom manager device 102), interaction with the classroom content (e.g., to answer questions), and so on.

The student device 106 is illustrated as in communication with the teacher device 104. This may be performed directly between the teacher and student device 104, 106 and/or indirectly through use of the classroom manager device 102.

The teacher device 104 is illustrated as including a teacher module 504 that is representative of functionality of the teacher device 104 to interact and manage usage of classroom content 316. The teacher module 504, for instance, may be configured to allow access to portions of the classroom content 316 that are not permitted for the student device 106, such as teacher answers, lecture materials, and so on. The classroom content, for instance, may include materials that correspond to a lesson plan for discussion in a classroom and a homework assignment that corresponds to the lesson plan.

The teacher module 504 may also include a student device manager module 506 that is configured to manage interaction of the student devices 106 with the classroom content 316. This may include indications of which portions of the classroom content 316 are being displayed by respective student devices. The student device manager module 506 may also include functionality to control output of content on respective student devices 106, such as to specify a particular page, figure, multimedia content, and so on that is to be output for use as part of a lecture. In this way, a teacher using the teacher device 104 is given a degree of control over the student devices 106, thereby promoting participation and learning by limiting possible distractions. A variety of other examples are also contemplated, such as to employ the classroom device 102 to manage interaction between student devices 106, 108, an example of which is described as follows and shown in a corresponding figure.

FIG. 6 depicts a system 600 in an example implementation in which communication between student devices 106, 108 by the classroom manager device 102 is shown. As before, the student devices 106, 108 are illustrated as including respective student module 602, 604 that are representative of functionality of the device to interact with classroom content 316. This may include output of classroom content (e.g., from local storage, streamed from a classroom device 102), interaction with the classroom content (e.g., to answer questions), and so on. Further, the classroom manager device 102 may be configured to restrict direct access between the student devices 106, 108 by limiting a local wireless network to connections made via the classroom manager device 102.

The classroom manager device 102 may be configured to act as a firewall to manage access of the student devices 106, 108 with a wide area network (WAN), such as the Internet. Further, this access may be managed to be different than that afforded to the teacher device 104, such as to grant limited access to student devices 106, 108 and remove at least some of these limitations for the teacher device 104.

The classroom manager device 102 may also be configured to manage communications between the student devices 106, 108. This may include management of communications that are performed directly between the devices through use of policies, such as to permit access to classroom content and communications relating to classroom content and restrict other access. Indirect communications may also be managed that are performed via the classroom manager device 102 between the student devices 106, 108. This may include keyword analysis, content analysis (e.g., images), and so on.

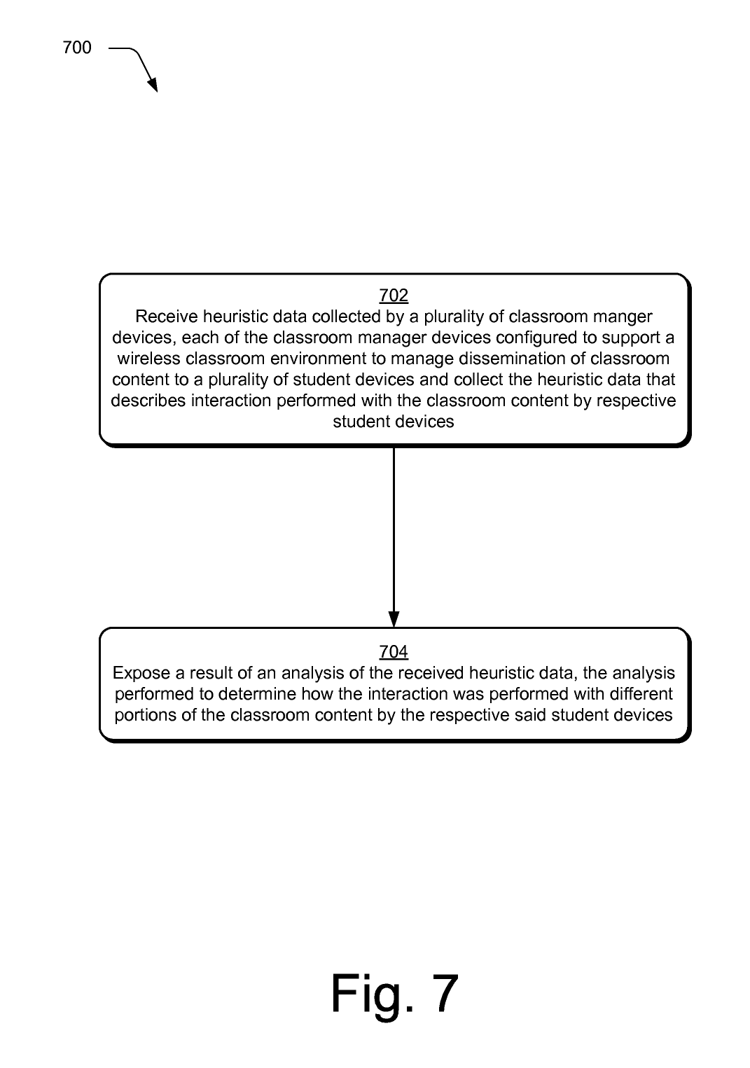

FIG. 7 illustrates an example method 700 of operation of a wireless hardware device.

At 702, heuristic data is received that is collected by a plurality of classroom manger devices, each of the classroom manager devices configured to support a wireless classroom environment to manage dissemination of classroom content to a plurality of student devices and collect the heuristic data that describes interaction performed with the classroom content by respective said student devices. As previously described in relation to FIG. 4, a variety of different types of heuristic data may be collected that describes a variety of different interactions.

At 704, a result is exposed of an analysis of the received heuristic data, the analysis performed to determine how the interaction was performed with different portions of the classroom content by the respective said student devices. The result, for instance, may be displayed in a user interface, made available via an application programming interface, and so on.

Example System-on-Chip

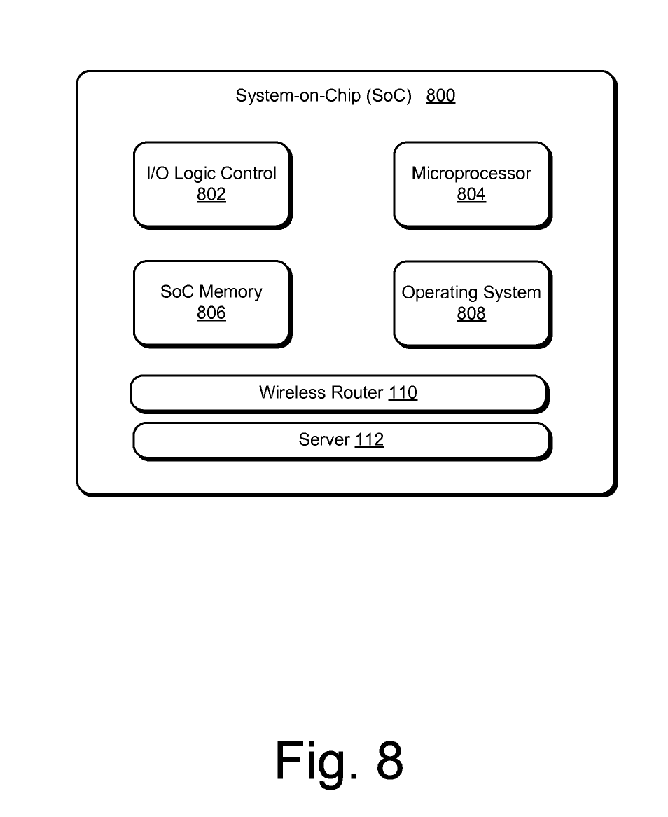

As noted above, the described techniques can be performed with an integrated circuit having a wireless router 110 and/or server 112. In some embodiments, the techniques can also be performed with other apparatuses, such as a system-on-chip, in whole or in part. FIG. 8 illustrates such a case, with an example System-on-Chip (SoC) 800. An SoC can be implemented in a fixed or mobile device, such as any one or combination of a computer device, television set-top box, video processing and/or rendering device, Ethernet interface, switch, appliance device, gaming device, electronic device, vehicle, and/or workstation.

SoC 800 can be integrated with electronic circuitry, a microprocessor, memory, input-output (I/O) logic control, communication interfaces and components, other hardware, firmware, and/or software needed to run an entire device. SoC 800 can also include an integrated data bus (not shown) that couples the various components of the SoC for data communication between the components. A device that includes SoC 800 can also be implemented with many combinations of differing components.

In this example, SoC 800 includes various components such as an input-output (I/O) logic control 802 (e.g., to include electronic circuitry) and a microprocessor 804 (e.g., any of a microcontroller or digital signal processor). SoC 800 also includes SoC memory 806, which can be any type of random access memory (RAM), a low-latency nonvolatile memory (e.g., flash memory), read only memory (ROM), and/or other suitable electronic data storage. SoC memory 806 may be separate from (shown) or integrated with (not shown) memory 110 depending on the architecture of SoC 800. SoC 800 can also include various firmware and/or software, such as an operating system 808, which can be computer-executable instructions maintained by SoC memory 806 and executed by microprocessor 804. SoC 800 can also include other various communication interfaces and components, wireless LAN (WLAN) or PAN (WPAN) components, other hardware, firmware, and/or software.

SoC 800 may include part of the classroom manager device 102 of FIG. 1, such as by including one or more modules to implement the wireless router 110, server 112, and so on of FIGS. 1 and 2.

Although the subject matter has been described in language specific to structural features and/or methodological techniques and/or acts, it is to be understood that the subject matter defined in the appended claims is not necessarily limited to the specific features, techniques, or acts described above, including orders in which they are performed.

What is claimed is:

1. A classroom manager device comprising:
a housing;
a wireless router disposed within the housing, wherein the wireless router is configured to instantiate a local wireless network, and support communication between the local wireless network and a wide area network; and
a server disposed within the housing, wherein the server is communicatively coupled to the wireless router to manage a wireless classroom environment including a first device and one or more second devices, wherein the first device is configured to manage operation of the one or more second devices.

2. The classroom manager device as recited in claim 1, wherein the housing and includes an electrical plug are configured such that when received within an electrical socket in a vertical orientation, the housing is supported to hang from the electrical socket.

3. The classroom manager device as described in claim 1, further comprising a physical network connection device configured to support a physical and communicative coupling between the wide area network and the wireless router.

4. The classroom manager device as described in claim 1, further comprising a physical bus device configured to support a physical and communicative coupling between the server and a peripheral device.

5. The classroom manager device as described in claim 1, wherein the server is configured to support management of the one or more student devices by the first device through control of which portions of classroom content are output by the one or more second devices as indicated by the first device.

6. The classroom manager device as described in claim 1, wherein the server includes a classroom content management module that is configured to collect heuristic data that describes student interaction with classroom content.

7. The classroom manager device as described in claim 6, wherein the heuristic data describes an amount of time a student has interacted with particular portions of the classroom content.

8. The classroom manager device as described in claim 6, wherein the classroom content management module is configured obtain the classroom content via the wide area network and disseminate the classroom content to the one or more second devices.

9. The classroom manager device as described in claim 1, wherein the wireless router is configured to act as a firewall to manage access of the one or more second devices and the first device to the wide area network such that the first device is permitted access that is not permitted to the one or more second devices.

10. The classroom manager device as described in claim 8, wherein the wireless router is configured to support communication between said second devices via the local wireless network, said second devices configured to not permit direct wireless communication between the second devices.

11. A method comprising:
instantiating a local wireless network using a wireless router of a classroom manager device, the local wireless network configured to support communication between the local wireless network and a wide area network; and
managing a wireless classroom environment using a server of the classroom manager device, that includes a first device and one or more second devices, wherein the first device is configured to manage operation of the one or more second devices via the server.

12. The method as described in claim 11, wherein the server is configured to support management of the one or more student devices by the first device through control of which portions of classroom content are output by the one or more second devices as indicated by the first device.

13. The method as described in claim 11, wherein the server is configured to support management of the one or more student devices by the first device through control of which portions of classroom content are output by the one or more second devices as indicated by the first device.

14. The method as described in claim 11, wherein the server includes a classroom content management module that is configured to collect heuristic data that describes student interaction with classroom content.

15. The method as described in claim 14, wherein the heuristic data describes an amount of time a student has interacted with particular portions of the classroom content.

16. The method as described in claim 13, wherein the classroom content management module is configured obtain the classroom content via the wide area network and disseminate the classroom content to the one or more second devices.

17. The method as described in claim 11, wherein the wireless router is configured to act as a firewall to manage access of the one or more second devices and the first device to the wide area network such that the first device is permitted access that is not permitted to the one or more second devices.

18. One or more computer-readable storage media comprising instructions stored thereon that, responsive to execution on a computing device, causes the computing device to perform operations comprising:
instantiating a local wireless network using a wireless router of a classroom manager device, the local wireless network configured to support communication between the local wireless network and a wide area network; and
managing a wireless classroom environment using a server of the classroom manager device, that includes a first device and one or more second devices, wherein the first device is configured to manage operation of the one or more second devices via the server.

19. One or more computer-readable storage media comprising as described in claim 18, wherein the server is configured to support management of the one or more student devices by the first device through control of which portions of classroom content are output by the one or more second devices as indicated by the first device.

20. One or more computer-readable storage media comprising as described in claim 18, the server is configured to support management of the one or more student devices by the first device through control of which portions of classroom content are output by the one or more second devices as indicated by the first device.
